(19) United States
(12) Patent Application Publication
(10) Pub. No.: US 2025/0273900 A1
(43) Pub. Date: Aug. 28, 2025

(54) Visual Lifetime Assessment Indicator for an Electrical Connector

(71) Applicant: Eaton Intelligent Power Limited, Dublin (IE)

(72) Inventors: Atul Pandey, Varanasi (IN); Anand Kumar Ramachandran, Pune (IN); Onkar Pradeeprao Bhise, Pune (IN); Prashant Pramodrao Zatale, Pune (IN); Brian Andrew Korves, Delafield, WI (US)

(21) Appl. No.: 19/059,686

(22) Filed: Feb. 21, 2025

(30) Foreign Application Priority Data
Feb. 26, 2024 (IN) 202411013676

(51) Int. Cl. H01R 13/53; H01R 13/40; H01R 13/637

(52) U.S. Cl. CPC H01R 13/53; H01R 13/40; H01R 13/637

(57) ABSTRACT

A system includes: a separable connector including an electrically insulating housing and an electrically conductive probe and an insert. The insert includes: an electrically insulating body including an open end configured to receive the electrically conductive probe; an electrically conductive assembly inside the electrically insulating body and configured to electrically connect to the electrically conductive probe; and an arc snuffer. The arc snuffer includes: an inner ablative arc-quenching portion that surrounds an open interior between the open end and the electrically conductive assembly, the open interior being configured to receive the electrically conductive probe; and a layer on exterior surface of the inner ablative arc-quenching portion. The layer is configured to produce a visible indicator related to a remaining life of the insert when the layer is exposed to an arc.

### CROSS-REFERENCE TO RELATED APPLICATION

This application claims priority to Indian patent application Ser. No. 20/241,1013676, filed Feb. 26, 2024 and titled VISUAL LIFETIME ASSESSMENT INDICATOR FOR AN ELECTRICAL CONNECTOR, which is incorporated herein by reference in its entirety.

### TECHNICAL FIELD

This disclosure relates to a visual lifetime assessment indicator for an electrical connector.

### BACKGROUND

Arcing occurs during use of electrical equipment. For example, arcing occurs when conductors are separated or joined while under load. Fault conditions, such as short circuits, also produce arcs. Arcing may damage components in the electrical equipment.

### SUMMARY

In one aspect, a system includes: a separable connector including an electrically insulating housing and an electrically conductive probe and an insert. The insert includes: an electrically insulating body including an open end configured to receive the electrically conductive probe; an electrically conductive assembly inside the electrically insulating body and configured to electrically connect to the electrically conductive probe; and an arc snuffer. The arc snuffer includes: an inner ablative arc-quenching portion that surrounds an open interior between the open end and the electrically conductive assembly, the open interior being configured to receive the electrically conductive probe; and a layer on exterior surface of the inner ablative arc-quenching portion. The layer is configured to produce a visible indicator related to a remaining life of the insert when the layer is exposed to an arc.

Implementations may include one or more of the following features.

The layer may include a smoke-producing material that produces smoke in response to exposure to the arc, and, in these implementations, the produced smoke is visually distinct from smoke produced by the inner ablative arc-quenching portion. The smoke-producing material may include a dye, and the produced smoke has a color determined by the dye.

The separable connector may be an elbow-shaped cable connector, the insert may be a bushing insert, and the electrically insulating housing may be configured to mechanically latch onto an exterior of the electrically insulating body.

The arc snuffer also may include an outer portion, and, in these implementations, the layer is between the inner ablative arc-quenching portion and the outer portion.

The layer may be configured to produce a visible indicator related to a remaining life of the insert when the layer is exposed to an arc that forms during a loadmake operation when the electrically conductive probe is connected to the electrically conductive assembly or during a loadbreak operation when the electrically conductive probe is separated from the electrically conductive assembly.

In another aspect, an electrical connector includes: an electrically insulating body including an open end; an electrically conductive shield inside the electrically insulating body; an electrically conductive assembly inside the electrically insulating body; and an arc snuffer adjacent to the electrically conductive assembly, the arc snuffer including: an inner portion that defines an open interior connected to the open end, an outer portion, and a layer between the inner portion and the outer portion.

Implementations may include one or more of the following features.

The inner portion may include an ablative material.

The layer may produce smoke in response to exposure to heat. The produced smoke may be visually distinct from matter produced by the inner portion. The inner portion may be a first annulus, the outer portion may be a second annulus, and the layer may be a coating on the first annulus. The outer portion and the inner portion may be the same material.

The electrically conductive assembly may include: an electrically conductive contact; an electrically conductive piston; and an electrically conductive contact holder in physical contact with the electrically conductive piston, the electrically conductive contact holder defining a connection point configured to electrically connect to a conductor surrounded by a bushing.

In another aspect, an apparatus includes: an arc-prone device including: an electrically conductive assembly; and an arc snuffer surrounding the electrically conductive assembly, the arc snuffer including: an inner portion, and an outer portion; and a visual indicator related to remaining lifetime of the arc-prone device, the visual indicator including a layer between the inner portion and the outer portion. The layer may include a smoke-producing material, the inner portion and the outer portion may be the same ablative material, and the layer may be a coating on an exterior surface of the inner portion. The inner portion may be an ablative material that produces smoke and debris when exposed to an electrical arc, and the layer may produce smoke that has at least one property that is visually distinguishable from smoke produced by the ablative material. The at least one property may be color, and the layer may produce smoke that is a different color than smoke produced by the ablative material.

In another aspect, an arc snuffer includes: an inner portion including an ablative material, the inner portion defining an open interior; an outer portion that surrounds the inner portion, the outer portion including an ablative material; and a layer between the inner portion and the outer portion. The layer includes a smoke-producing material.

Implementations may include one or more of the following features.

The layer may be a coating on an outer surface of the inner portion, and the coating may contact an inner side of the outer portion.

The inner portion and the outer portion may be concentric.

Implementations of any of the techniques described herein may include a system, a device, and/or a method. The details of one or more implementations are set forth in the accompanying drawings and the description below. Other features will be apparent from the description and drawings, and from the claims.

### DRAWING DESCRIPTION

FIG. 1 is a block diagram of a system that includes an arc-prone device.

FIG. 2A is a side perspective view of an arc snuffer.

FIG. 2B is a side cross-sectional view of the arc snuffer of FIG. 2A.

FIG. 2C is a radial cross-sectional view of the arc snuffer of FIG. 2A taken along the line C-C′ of FIG. 2B.

FIG. 2D is a radial cross-sectional view of the arc snuffer of FIG. 2A prior to a first arcing event.

FIG. 2E is a detailed view of the inset labeled E in FIG. 2D.

FIG. 2F is a radial cross-sectional view of the arc snuffer of FIG. 2A, taken after the inner portion is completely ablated, the visual indicator layer is exposed to the open interior.

FIG. 2G is a radial cross-sectional view of the arc snuffer of FIG. 2A, during an arcing event that occurs after the inner portion has been completely ablated.

FIGS. 3A and 3B are block diagrams of an electrical power distribution system that includes a separable electrical connector.

FIG. 4 is a cross-sectional view of a loadbreak bushing insert.

FIG. 5 shows the bushing insert of FIG. 4 mounted to a bushing.

### DETAILED DESCRIPTION

An arc snuffer 160 is disclosed. The arc snuffer 160 may be used in any medium-voltage or high-voltage arc-prone device or arc-prone connection point. Medium-voltage devices may be, for example, devices that have a voltage rating of 1 kilovolt (kV) or greater. The arc snuffer 160 includes a visual indication layer 162 that provides an indication that is visually perceivable and related to the remaining life of the arc snuffer 160, the device in which the arc snuffer 160 is used, and/or components within the device in which the arc snuffer 160 is used.

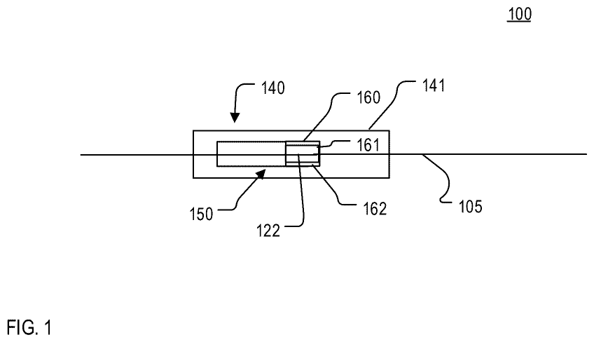

FIG. 1 is a block diagram of a system 100 that includes an arc-prone device 140 with an electrical current path 105 that is prone to arcing at an arcing region 122. The arc-prone device 140 is any device that experiences arcing. The arc-prone device 140 may be, for example, a switching system or an electrical connector that is configured for loadbreak or loadmake operations. A loadbreak operation occurs when the electrical current path 105 is opened under load (while the electrical current path 105 is energized with electrical current). A loadmake operation occurs when the electrical current path 105 is closed under load (while one or more portions of the electrical current path 105 are energized). Electrical arcing may occur in the arcing region 122 during loadmake and loadbreak operations. Electrical arcing also may occur during a fault closure condition, which occurs when the electrical current path 105 is closed while one portion of the path 105 is energized by a fault, such as a short circuit. Other conditions, such as faults and short circuit conditions, also may cause arcing on the electrical current path 105.

The arc-prone device 140 includes the arc snuffer 160, which surrounds the arcing region 122 or surrounds a portion of the current path 105 near the arcing region 122. The arcing region 122 may be, for example, a portion of the electrical current path 105 where two separate electrical conductors can be joined or separated. The arc snuffer 160 includes an inner portion 161 and the visual indicator layer 162. The inner portion 161 is an ablative material that releases an arc-quenching substance in the presence of an arc. The arc-quenching substance extinguishes or aids in the extinguishing of arcs that form in the arcing region 122. The inner portion 161 is exposed to the arcing region 122 and provides a buffer between the arcing region 122 and the visual indicator layer 162. Each time an arc is formed in the arcing region 122, the inner portion 161 releases the arc-quenching substance and the thickness of the inner portion 161 decreases until the inner portion 161 is completely ablated and the visual indicator layer 162 is exposed.

The original thickness of the visual indicator layer 162 and the material properties of the visual indicator layer 162 are known, and, based on this information, the amount of arcing required to fully ablate the inner portion 161 may be determined. Although the arc-prone device 140 is intended to perform more than one loadmake, loadbreak, and/or fault closure operation and also may be exposed to other types of arcing, the device 140 has a finite lifetime. Moreover, arcing is a dominant factor in the lifetime of the medium-voltage or high-voltage arc-prone device 140. For example, the arcing may cause deposits to form on an electrical contact assembly 150 that is electrically connected to the path 105 and/or may damage a housing 141 of the device 102. The absence of the inner portion 161 provides an assessment of the amount of arcing that has occurred in the arc-prone device 140. In this way, the visual indicator layer 162 provides a reliable and easily understood visual lifetime assessment for the arc-prone device 140.

By providing a reliable visual lifetime assessment of the arc-prone device 140, the arc snuffer 160 improves the overall usability and safety of the arc-prone device 140. The arc snuffer 160 also promotes efficient use of resources. For example, the visible lifetime assessment may be used by the operator of the system 100 and/or operator of the arc-prone device 140 to schedule maintenance, repair, and/or replacement of the arc-prone device 140 for a time when downtime will cause minimal customer inconvenience.

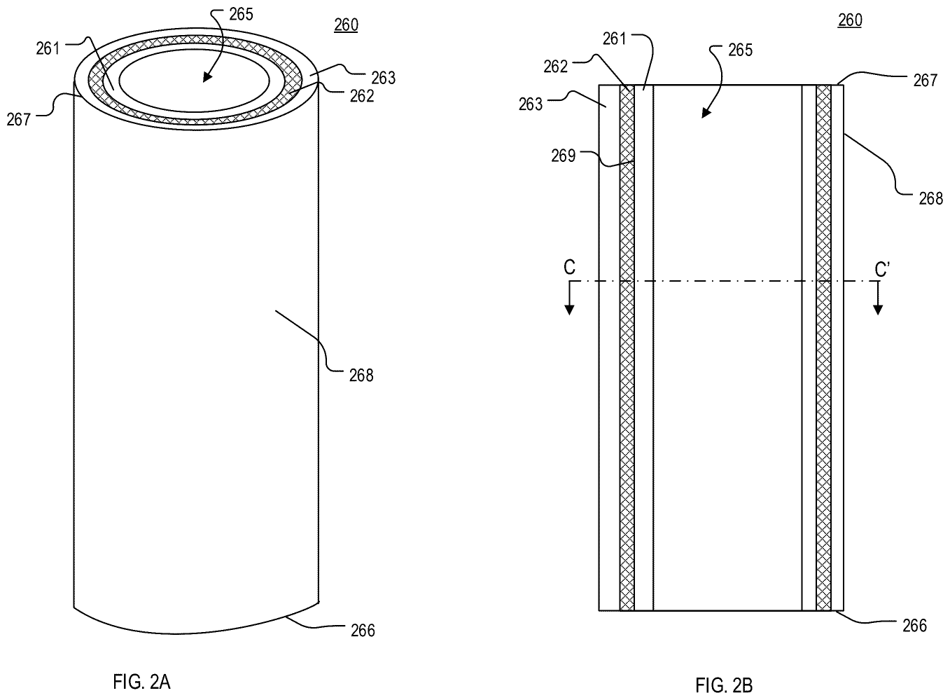

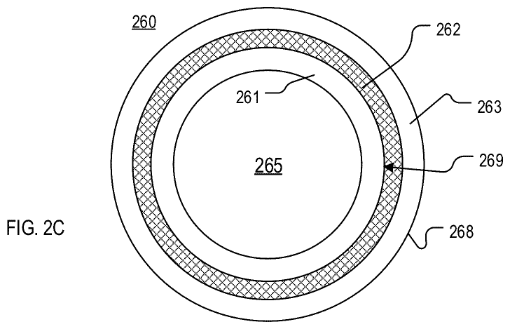

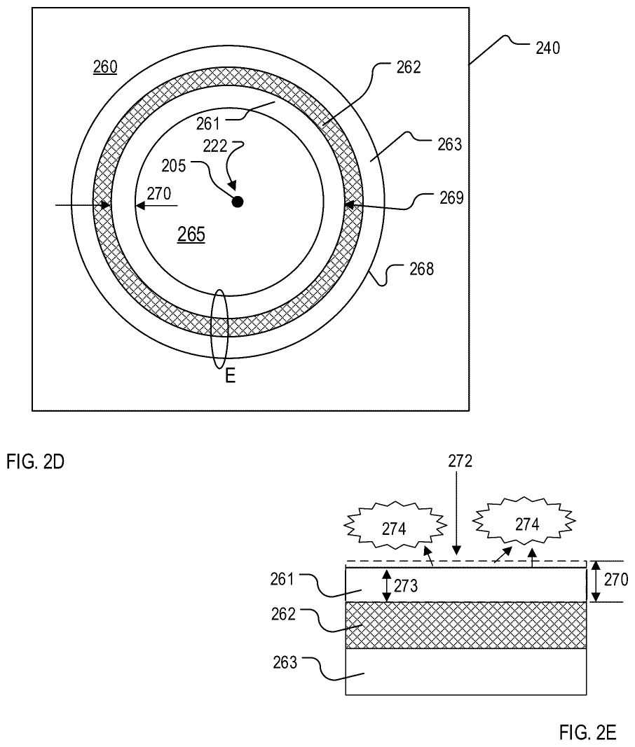

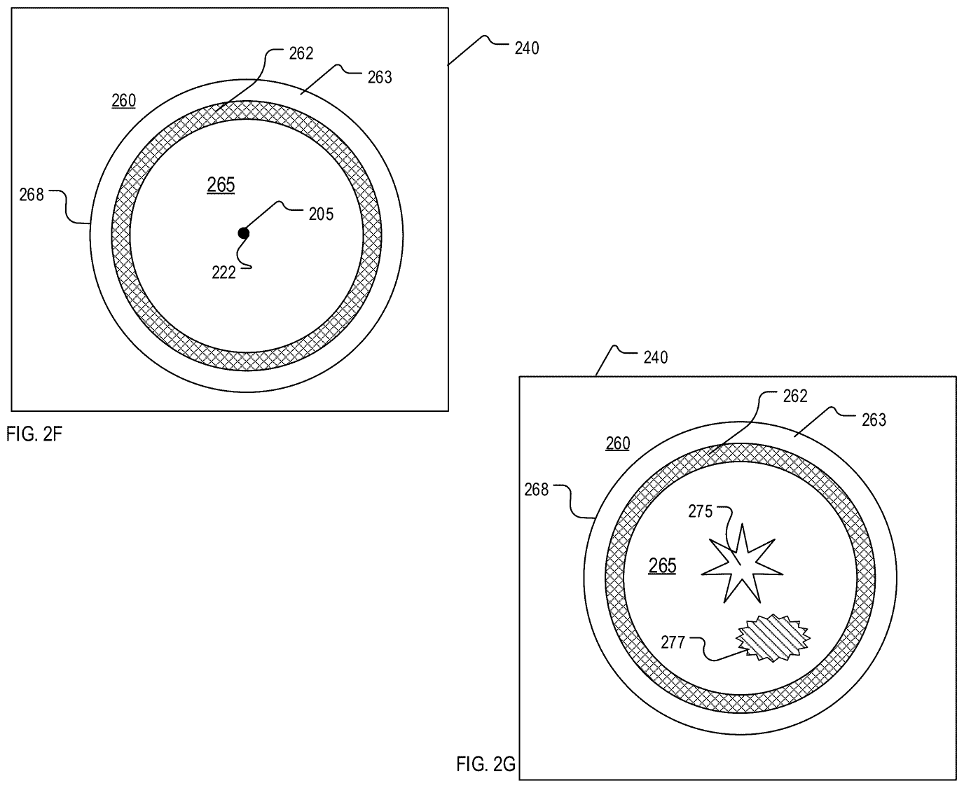

FIG. 2A is a side perspective view of an arc snuffer 260. FIG. 2B is a side cross-sectional view of the arc snuffer 260. FIG. 2C is a radial cross-sectional view of the arc snuffer along the line C-C′ of FIG. 2B. The arc snuffer 260 may be used in the arc-prone device 140 instead of the arc snuffer 160.

The arc snuffer 260 is a generally cylindrical tube structure that extends in the Z direction from a first end 266 to a second end 267. The arc snuffer 260 includes an inner portion 261, a visual indicator layer 262 (shown in cross-hatch shading), and an outer portion 263. The visual indicator layer 262 is between the inner portion 261 and the outer portion 263. In the example shown, the inner portion 261, the visual indicator layer 262, and the outer portion 263 are concentric cylindrical tubes, and the inner portion 261 defines an open interior 265 that passes through the arc snuffer 260 in the Z direction.

The inner portion 261 is an ablative material that produces an arc-quenching or arc-extinguishing substance in the presence of an arc. Any material that produces an arc-quenching substance in the presence of an arc may be used as the inner portion 261. Examples of materials that may be used for the inner portion 261 include, for example, chalk, quartz, and plastics such as thermoset. In the example shown, the inner portion 261 is a tube of solid material. Other implementations are possible. For example, the inner portion 261 may be a powder held together with a resin or adhesive.

The visual indicator layer 262 is on an outer side 269 of the inner portion 261. The visual indicator layer 262 may be placed on the outer side 269 in any manner. For example, the visual indicator layer 262 may be a coating on the outer side 269, a pelletized substance that is captured between the outer side 269 and the outer portion 263, a powdery substance that is captured between the outer side 269 and the outer portion 263, or a tube of material that is in contact with the outer side 269.

The layer 262 includes a material that has at least one characteristic that visually distinguishes it from the inner portion 261. For example, the layer 262 may be a pyrotechnic smoke-producing material that produces smoke in the presence of an arc, with the smoke produced by the layer 262 being a different color than smoke produced by the inner portion 261. In some implementations, the layer 262 is a colored pyrotechnic smoke-producing composition that has an oxidizer, fuel, flame retardant, dye, coolant, and a binder. In these implementations, the oxidizer may be, for example, potassium chloride. The fuel may be, for example, starch, dextrose, lactose, and/or sucrose. The coolant may be, for example, sodium bicarbonate, or magnesium carbonate. The binder may be, for example, nitrocellulose or a halogen-free thermoplastic. The flame retardant may be, for example, a nitrogen-rich compound. In these implementations, material for the layer 262 may include 20-35% by mass of oxidizer, 15-25% by mass of fuel, 5-15% by mass of flame retardant, 27-40% by mass of dye, 8-18% by mass of coolant, and 1-2% by mass of binder.

The radial thickness of the visual indicator layer 262 for a particular application depends on the characteristics of the material used for the layer 262 and the amount of smoke to be produced in the presence of an arc. For example, the radial thickness may vary based on an ablation rate of the material used for the layer 262 and/or the volume of the material used for the layer 262. In some implementations, the visual indicator layer 262 has a radial thickness of, for example, 0.1 millimeter (mm) to 0.5 mm.

The outer portion 263 surrounds the visual indicator layer 262 and the inner portion 261. The outer portion 263 may be made of the same material as the inner portion 261. The outer portion 263 has an exterior surface 268 that is also the exterior surface of the arc snuffer 260.

Referring also to FIG. 2D, in operational use, the arc snuffer 260 is used with an arc-prone device 240 that has a conductive path 205. The conductive path 205 is in the open interior 265 of the arc snuffer 260, with the arc snuffer 260 positioned around or near an arcing region 222 on the path 205. Arcs that form in the arcing region 222 due to, for example, a loadmake, loadbreak, or fault closure operation are referred to as arcing events.

FIG. 2D shows the arc snuffer 260 prior to the first arcing event. Prior to the first arcing event, the inner portion 261 has an initial thickness 270. Referring also to FIG. 2E, which illustrates a detailed view of the inset labeled E in FIG. 2D, when an arc 272 is present in the open interior 265, the arc 272 ablates the inner portion 261, producing an arc-quenching substance 274. The arc-quenching substance 274 may include plasma, vapor, smoke, gas liquid, and/or solid particles. Additionally, the arc-quenching substance 274 and/or other substances may be emitted from the inner portion 261 and may escape to an exterior of the arc-prone device 240. Additionally, the ablation by the arc 272 decreases the thickness of the inner portion 261 to a reduced thickness 273. Prior to being completely ablated, the inner portion 261 provides a buffer between the open interior 265 and the visual indication layer 262.

The arc 272 is extinguished, and the arc-prone device 240 is used in subsequent arc-producing operations. Prior to being fully ablated, the arc-quenching substance 274 is produced in response to each subsequent arcing event in the open interior 265, and the radial thickness of the inner portion 261 decreases each time an arcing event occurs in the open interior 265.

Referring also to FIG. 2F, after the inner portion 261 is completely ablated, the visual indicator layer 262 is exposed to the open interior 265. FIG. 2G illustrates an arcing event that occurs after the inner portion 261 has been completely ablated. An arc 275 forms in the open interior 265. The arc 275 interacts with the visual indicator layer 262, which produces matter 277 in response to exposure to the arc 275. The matter 277 has at least one characteristic that distinguishes it from the arc-quenching substance 274. For example, in implementations in which the visual indicator layer 262 is a colored pyrotechnic smoke-producing composition, the matter 277 includes smoke that has a color that is pre-determined by the particular chemicals in the pyrotechnic smoke-producing composition. The pre-determined color of the smoke is different from the color or colors of smoke produced by the inner portion 261 and is also different in appearance than the arc-quenching substance 274.

After the visual indicator layer 262 is consumed, if the arc-prone device 240 is used while the operator prepares to repair or replace the arc-prone device 240, additional arcing events will ablate the outer portion 263 and are extinguished by arc-quenching substances produced by the outer portion 263.

The initial thickness 270 of the inner portion 261 is selected such that the inner portion 261 will completely ablate after a pre-determined number of arcing events. The initial thickness 270 may be selected such that the inner portion 261 completely ablates after the number of arcing events in the open interior 265 totals a pre-determined percentage of total arcing events that the arc-prone device 240 is designed to handle safely in its lifetime. For example, the initial thickness 270 may be selected to fully ablate after 70%, 80%, or 90% of the total expected arcing events have occurred in the open interior 265. The percentage of total arcing events may be selected such that the visual indication layer 262 provides the visible indication to the operator sufficiently in advance of the expected end of the life of the arc-prone device 240 such that the operator is able to plan for replacement of the arc-prone device 240. In some implementations, the initial thickness 270 is selected based on a specific number of arcing events rather than a percentage of the total arcing events.

Regardless of the specific selection of the initial thickness 270, the visual indicator layer 262 is only exposed to arcing after the inner portion 261 is fully ablated. The visual indicator layer 262 does not produce the matter 277 until the inner portion 261 is fully ablated. In this way, the visual indicator layer 262 provides a distinct visually perceivable signal (the matter 277) that is related to the lifetime of the arc-prone device 240. Moreover, the matter 277 is observable from outside of the arc-prone device 240 during or shortly after a fault closure, loadbreak, or loadmake operation and does not necessarily require that the arc-prone device 240 or arc snuffer 260 be disassembled to inspect the visual indicator layer 262.

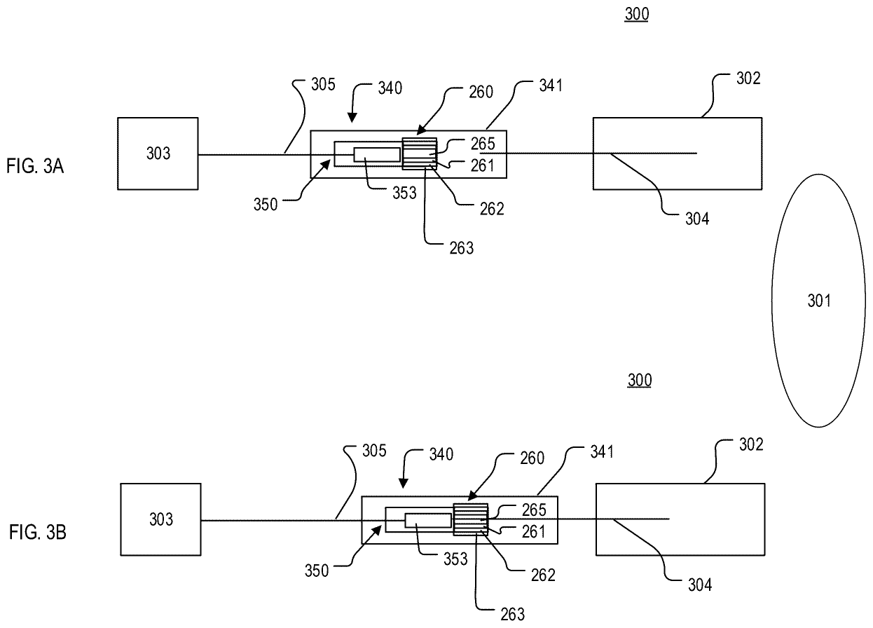

FIGS. 3A and 3B are block diagrams of an electrical power distribution system 300 that includes a separable electrical connector 340. The separable electrical connector 340 is an example of an arc-prone device 240 in which the arc snuffer 260 or the arc snuffer 160 may be used. The separable electrical connector 340 is shown with the arc snuffer 260. The electrical connector 340 may be, for example, a bushing insert, a loadbreak elbow connector, a cable connector, an elbow arrester, or a loadbreak T-shaped connector.

The electrical connector 340 includes a cable or wire 305 that is electrically connected to an electrically conductive assembly 350 inside an insulating housing 341 of the electrical connector 340. The electrically conductive assembly 350 includes an electrical contact 353. The cable 305 is also connected to an electrical node 303. The electrical node 303 may be, for example, a conductor in another electrical device or a grounding point. The electrical device 302 is any type of electrical device that includes an electrical connection point 304. For example, the electrical device 302 may be an electrical device (such as a transformer, capacitor bank, or voltage regulator) and the connection point 304 may be a conductor that extends through a bushing on the device 302. The electrical connector 340 is configured to be connected to and disconnected from the electrical connection point 304. When the electrically conductive assembly 350 and the connection point 304 are electrically connected, current can flow between the electrical device 302 and the node 303. When the contact assembly 350 and the connection point 304 are not electrically connected, current cannot flow between the electrical device 302 and the node 303.

The electrical connector 340 is configured for operation under load. In other words, the electrical connector 340 may be separated from the connection point 304 (FIG. 3A) or connected to the connection point 304 (FIG. 3B) without first interrupting electrical current that flows in the connection point 304 and the electrical contact 353. A loadmake operation occurs when the electrical connector 340 and the connection point 304 are connected under load. A loadbreak operation occurs when the electrical connector 340 and the connection point 304 are separated under load. During a loadmake operation, an arc forms between the electrical contact 353 and the connection point 304 as they approach each other. During a loadbreak operation, an arc forms between the electrical contact 353 and the connection point 304 as they separate from each other. Additionally, an arc forms as the electrical contact 353 and the connection point 304 move toward each other during a fault closure operation.

Regardless of the mechanism that produces the arc, each time an arc is formed, the inner portion 261 releases the arc-quenching substance that assists in extinguishing the arc. As discussed above, the thickness of the inner portion 261 decreases each time the portion 261 releases the arc-quenching substance.

Although the electrical connector 340 is re-useable and is intended to perform more than one loadmake, loadbreak, and/or fault closure operation, the electrical connector 340 has a finite usable lifetime that is partially determined by the amount of arcing the connector 340 experiences. The usable lifetime of the electrical connector 340 may be quantified as a number of operations that the electrical connector 340 is expected to perform and/or as a time period.

Legacy electrical connectors lack a controlled and intentional visible life assessment indicator. For example, when examining a legacy electrical connector in the field, a technician or operator may attempt to estimate the amount of life remaining in the electrical connector by visually examining wear and carbon deposits on internal electrical contacts. However, the assessments provided by such examinations vary depending on the experience of the technician and the conditions under which the electrical connector is used. Furthermore, examination of the electrical contacts may require that the electrical connector be at least partially disassembled. Thus, these types of assessments may be inaccurate and may increase system downtime. Moreover, the inaccuracy of these estimations may lead to technicians replacing electrical connectors too soon or too late.

On the other hand, the electrical connector 340 includes the arc snuffer 260, which provides a reliable and easily understood visual lifetime assessment for the electrical connector 340. Moreover, the visual indicator layer 262 can provide the visual lifetime assessment when the electrical connector 340 is fully assembled and operational. By providing a reliable visual lifetime assessment of the electrical connector 340, the arc snuffer 360 improves the overall usability and safety of the electrical connector 340.

The electrical connector 340 may have any shape. For example, the electrical connector 340 may be substantially linear in shape, U-shaped, T-shaped, C-shaped, elbow-shaped, or L-shaped. The electrical connector 340 may be rated for loadbreak and loadmake operations at, for example, 200 Amperes (A), 600A, 900A, or 1200A and may have a rated voltage of up to 15 kilovolts (kV), up to 25 kV, or up to 35 kV. In some implementations, the electrical connector 340 is rated for operation at 35 kilovolts (kV) and 600A. These current and voltage values are provided as examples, and the electrical connector 340 may have a different rated current and/or voltage.

The device 302 is any type of device or system that utilizes electricity and that has a bushing configured for connection to the electrical connector 340. The device 302 may be, for example, a voltage regulator, a transformer, a switching apparatus, a junction, or a sectionalizing cabinet. The electrical power distribution system 300 includes an AC (alternating current) power grid 301. The power grid 301 is a three-phase power grid that operates at a fundamental frequency of, for example, 50 or 60 Hertz (Hz). The power grid 101 includes devices, systems, and components that transfer, distribute, generate, use, and/or absorb electricity. For example, the power grid 301 may include, without limitation, generators, power plants, electrical substations, transformers, renewable energy sources, distributed energy sources (DERs), transmission lines, reclosers and switchgear, fuses, surge arresters, combinations of such devices, and any other device used to transfer or distribute electricity.

The power grid 301 may be low-voltage (for example, up to 1 kilovolts (kV)), medium-voltage or distribution voltage (for example, between 1 kV and 46 kV), or high-voltage (for example, 46 kV and greater). The power grid 301 may include more than one sub-grid or portion. For example, the power grid 301 may include AC micro-grids, AC area networks, or

AC spot networks that serve particular customers. These sub-grids may be connected to each other via switches and/or other devices to form the grid 301. Moreover, sub-grids within the grid 301 may have different nominal voltages. For example, the grid 301 may include a medium-voltage portion connected to a low-voltage portion through a distribution transformer. All or part of the power grid 301 may be underground.

The electrical power distribution system 300 may include additional components and systems that are not shown or discussed above. For example, the electrical power distribution system 300 may include cabinets, transformers, transmission lines and cables, substations, and support structures, just to name a few. All or part of the electrical power distribution system 300 may be underground. Moreover, the device 302 may be underground, and the electrical connector 340 may be used underground or above ground.

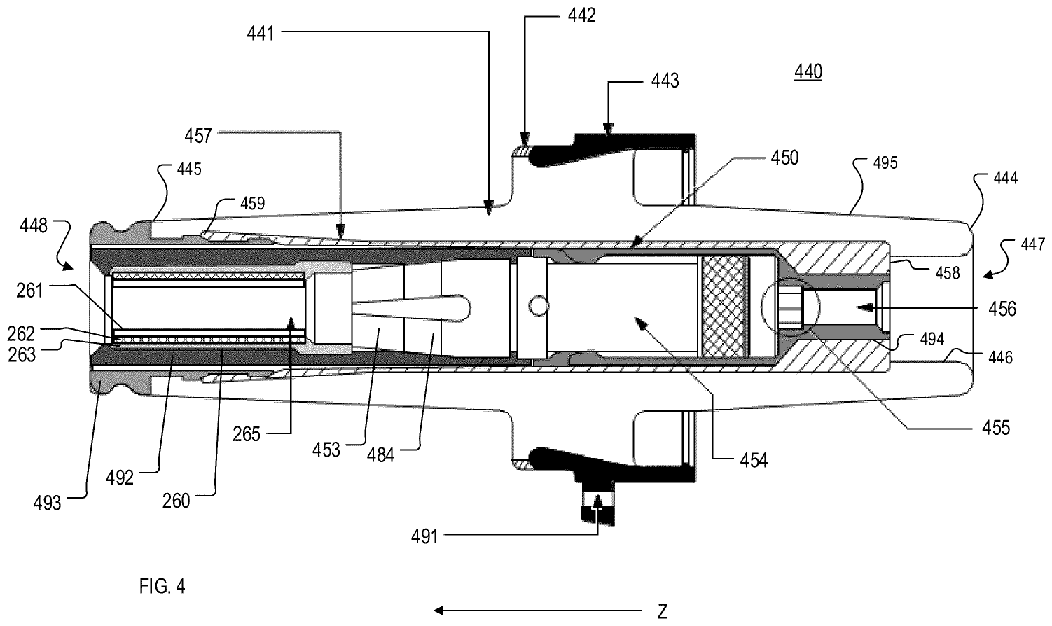

FIG. 4 is a cross-sectional view of a loadbreak bushing insert 440. The loadbreak bushing insert 440 is another example of an arc-prone device that includes the arc snuffer 260. The loadbreak bushing insert 440 includes an insulated housing 441 that extends along the Z direction from a first end 444 to a second end 445. The housing 441 has an opening 447 at the first end 444 and an opening 448 at the second end 445. The second end 445 is attached to an insulating element 493 that surrounds the opening 448. The insulating element 493 may be a nose piece. The housing 441 is made of any electrically insulating material. For example, the housing 441 may be a molded rubber or a polymer. In some implementations, the housing 441 is made of a cured ethylene propylene diene monomer (EPDM) rubber.

The housing 441 includes an electrically conductive shield 457 on an inner surface 446. The electrically conductive shield extends in the Z direction from a first shield end 458 to a second shield end 459. The electrically conductive shield 457 provides structural support and electrical shielding. The electrically conductive shield 457 may be, for example, a shell, sleeve, or casing. The electrically conductive shield 457 is made of any electrically conductive material. For example, the electrically conductive shield 457 may be made of copper or another metal.

The shield 457 includes inner side 494. The inner side 494 is in contact with a contact holder 450 and a sleeve 492. The contact holder 450 extends in the Z direction from the end 458 to a mid-portion of the electrically conductive shield 457. The contact holder 450 defines a connection point 455 that is configured to receive a tool to aid in installing the bushing insert 440 and an open shaft 456 that opens to the opening 447. The open shaft 456 may have connection features, such as threads or roughened regions.

The sleeve 492 extends in the Z direction from the mid-portion of the shield 457 past the second shield end 459. The contact holder 450 and the sleeve 492 are electrically conductive. For example, the contact holder 450 may be made of copper or another metal. The sleeve 492 may be made of an electrically conductive rubber.

The bushing insert 440 also includes an electrically conductive piston assembly 454 and a contact assembly 453. The piston assembly 454 is a one-piece element that is electrically conductive and is surrounded by the contact holder 450. The contact assembly 453 includes deflectable portions 484 configured to contact a conductor or probe of a separate device (such as a loadbreak elbow). The contact assembly 453 and the piston assembly 454 are made of any electrically conductive material such as, for example, copper. The contact holder 450 and the piston assembly 454 are in physical contact with each other. Additionally, the piston assembly 454 and the contact assembly 453 are in contact with each other. The piston assembly 454, the contact holder 450, and the sleeve 452 are configured to move along the Z axis relative to the shield 475 during a fault closure operation.

The arc snuffer 260 is surrounded by the sleeve 492 and is adjacent to the contact assembly 453, with the arc snuffer 260 between the opening 448 and the contact assembly 453. The open interior 265 of the arc snuffer 260 coincides with the opening 448 such that a probe of a separate device (such as a loadbreak elbow) can be inserted into the opening 448 and through the open interior 265 to connect to the contact assembly 453.

The bushing insert 440 also includes a semi-conductive shield 443, a latch indicator ring 442, and grounding tabs 491, all of which are on an outer side 495 of the housing 441. The semi-conductive shield 443 provides a dead-front shield for the bushing insert 440. The semi-conductive shield 443 may be any type of semi-conductive material that has a relatively low electrical conductivity. For example, the semi-conductive shield 443 may be an EPDM rubber that includes a relatively small amount of an electrically conductive additive or dopant. The latch indicator ring 442 is a molded visual indicator that provides an indication of proper connection between the bushing insert 440 and a bushing of a separate device. The grounding tabs 491 are molded into the semi-conductive shield 443 and allow for the attachment of a grounding wire to maintain deadfront safety.

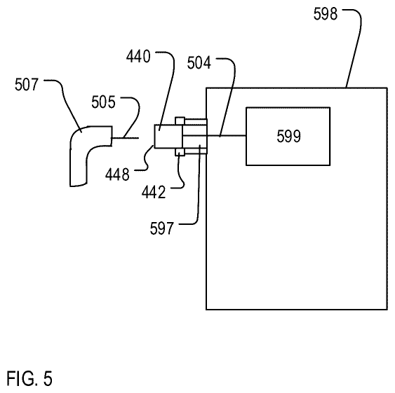

Referring also to FIG. 5, in operational use, the bushing insert 440 is mounted to a bushing 597 of a device 598. The device 598 is any type of electrical device that includes a bushing. The device 598 may be, for example, a transformer, a voltage regulator, a generator, or a capacitor bank. The bushing 597 surrounds a conductor 504 that is electrically connected to a circuit 599 in the interior of the device 598.

The bushing insert 440 is attached to the bushing 597 at the opening 447, and the conductor 504 is attached to the open shaft 456. A conductive probe 505 of a loadbreak elbow connector 507 is inserted through the opening 448 of the bushing insert 440 and is placed in contact with the contact assembly 453. Electrical current flows from the conductive probe 505 of the elbow connector 507 into the contact assembly 453 and the piston assembly 454, and into the contact holder 450 and shaft 465. The conductor 504 is electrically connected to the contact holder 450 at the shaft 465.

Thus, current can flow between the conductive probe 505 and the conductor 504 of the bushing 597. When a loadbreak operation occurs, the probe 505 is separated from the contact assembly 453 and an arc forms in the open interior 265 of the arc snuffer 260. The inner portion 261 produces the arc-quenching substance 274 and the arc is extinguished. After the inner portion 261 is fully ablated, the next arcing event causes the visual indicator layer 262 to emit the matter 277, which is visually distinguished from the arc-quenching substance 274 and other material produced by the inner portion 261. Thus, the production of the matter 277 provides a visual indication related to the remaining lifetime of the bushing insert 440.

These and other implementations are within the scope of the claims. For example, the arc snuffer 260 or the arc snuffer 160 may be included in the load break elbow 507 of FIG. 5.

What is claimed is:

1. A system comprising:
a separable connector comprising an electrically insulating housing and an electrically conductive probe; and
an insert comprising:
an electrically insulating body comprising an open end configured to receive the electrically conductive probe;
an electrically conductive assembly inside the electrically insulating body and configured to electrically connect to the electrically conductive probe; and
an arc snuffer comprising:
an inner ablative arc-quenching portion that surrounds an open interior between the open end and the electrically conductive assembly, the open interior being configured to receive the electrically conductive probe; and
a layer on exterior surface of the inner ablative arc-quenching portion, wherein the layer is configured to produce a visible indicator related to a remaining life of the insert when the layer is exposed to an arc.

2. The system of claim 1, wherein the layer comprises a smoke-producing material that produces smoke in response to exposure to the arc, and the produced smoke is visually distinct from smoke produced by the inner ablative arc-quenching portion.

3. The system of claim 2, wherein the smoke-producing material comprises a dye, and the produced smoke has a color determined by the dye.

4. The system of claim 1, wherein the separable connector comprises an elbow-shaped cable connector, the insert comprises a bushing insert, and the electrically insulating housing is configured to mechanically latch onto an exterior of the electrically insulating body.

5. The system of claim 1, wherein the arc snuffer further comprises an outer portion, and the layer is between the inner ablative arc-quenching portion and the outer portion.

6. The system of claim 1, wherein the layer is configured to produce a visible indicator related to a remaining life of the insert when the layer is exposed to an arc that forms during a loadmake operation when the electrically conductive probe is connected to the electrically conductive assembly or during a loadbreak operation when the electrically conductive probe is separated from the electrically conductive assembly.

7. An electrical connector comprising:
an electrically insulating body comprising an open end;
an electrically conductive shield inside the electrically insulating body;
an electrically conductive assembly inside the electrically insulating body; and
an arc snuffer adjacent to the electrically conductive assembly, the arc snuffer comprising: an inner portion that defines an open interior connected to the open end, an outer portion, and a layer between the inner portion and the outer portion.

8. The electrical connector of claim 7, wherein the inner portion comprises an ablative material.

9. The electrical connector of claim 7, wherein the layer produces smoke in response to exposure to heat.

10. The electrical connector of claim 9, wherein the produced smoke is visually distinct from matter produced by the inner portion.

11. The electrical connector of claim 7, wherein the inner portion is a first annulus, the outer portion is a second annulus, and the layer comprises a coating on the first annulus.

12. The electrical connector of claim 7, wherein the outer portion and the inner portion are the same material.

13. The electrical connector of claim 7, wherein the electrically conductive assembly comprises: an electrically conductive contact; an electrically conductive piston; and an electrically conductive contact holder in physical contact with the electrically conductive piston, the electrically conductive contact holder defining a connection point configured to electrically connect to a conductor surrounded by a bushing.

14. An apparatus comprising:
an arc-prone device comprising:
an electrically conductive assembly; and
an arc snuffer surrounding the electrically conductive assembly, the arc snuffer comprising: an inner portion, and an outer portion; and
a visual indicator related to remaining lifetime of the arc-prone device, the visual indicator comprising a layer between the inner portion and the outer portion.

15. The apparatus of claim 14, wherein the layer comprises a smoke-producing material, the inner portion and the outer portion comprise the same ablative material, and the layer is a coating on an exterior surface of the inner portion.

16. The apparatus of claim 14, wherein the inner portion comprises an ablative material that produces smoke and debris when exposed to an electrical arc, and the layer produces smoke that has at least one property that is visually distinguishable from smoke produced by the ablative material.

17. The apparatus of claim 16, wherein the at least one property comprises color, and the layer produces smoke that is a different color than smoke produced by the ablative material.

18. An arc snuffer comprising:
an inner portion comprising an ablative material, the inner portion defining an open interior;
an outer portion that surrounds the inner portion, the outer portion comprising an ablative material; and
a layer between the inner portion and the outer portion, wherein the layer comprises a smoke-producing material.

19. The arc snuffer of claim 18, wherein the layer is a coating on an outer surface of the inner portion, and the coating contacts an inner side of the outer portion.

20. The arc snuffer of claim 18, wherein the inner portion and the outer portion are concentric.
